(19) United States
(12) Patent Application Publication
(10) Pub. No.: US 2025/0259506 A1
(43) Pub. Date: Aug. 14, 2025

(54) GAME SYSTEM AND METHOD FOR PROVIDING VARIABLE ODDS WITH IMAGE SYNTHESIS DISPLAY

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 19/193,645

(22) Filed: Apr. 29, 2025

Related U.S. Application Data
(63) Continuation of application No. 19/072,196, filed on Mar. 6, 2025.
Application No. 19/072,196 is a continuation-in-part of application No. 17/915,980, filed on Sep. 29, 2022, now Pat. No. 12,249,214.
Application No. 19/072,196 is a continuation-in-part of application No. 18/251,793, filed on May 4, 2023.

(51) Int. Cl. G07F 17/32; G06T 7/70

(52) U.S. Cl. CPC G07F 17/323; G06T 7/70; G07F 17/3209; G07F 17/3211

(57) ABSTRACT

The present invention generates at least one set of variable odds for at least one payout odds of a game result by an odds processing unit. The number of the variable odds are more than two, and one of the variable odds replaces the corresponding payout odds. The numerical values of parts of the variable odds are lower than the numerical values of the corresponding payout odds. By lowering the numerical values of some of the variable odds, the numerical values of the others of the variable odds can be increased, thereby ensuring that a maximum possible value of the variable odds is attractive enough to players.

Additionally, an image synthesis processing unit is provided for generating a synthesized image. By displaying the synthesized image, an immersive experience is enhanced.

### CROSS-REFERENCE TO RELATED APPLICATIONS

This application is a continuation of co-pending U.S. patent application Ser. No. 19/072,196, filed Mar. 6, 2025, which is:
a continuation-in-part of U.S. patent application Ser. No. 17/915,980, filed Sep. 29, 2022, which is a national stage entry of International Application Ser. No. PCT/CN2020/082704, filed Apr. 1, 2020; and
a continuation-in-part of U.S. patent application Ser. No. 18/251,793, filed May 4, 2023, which is a national stage entry of International Application Ser. No. PCT/CN2020/133669, filed Dec. 3, 2020.

Each of these priority applications is incorporated by reference herein in its entirety.

### FIELD OF THE INVENTION

The present invention relates to game systems including a synthesized image display. More particularly, the invention relates to game systems and methods that generate a numerical value of variable odds to attract players through the display of synthesized images that increase credibility and enhance a sense of immersion during gameplay.

### BACKGROUND OF THE INVENTION

Some gambling game systems include an incentive apparatus to modify (e.g., increase) the payout odds of the game. The incentive apparatus may include a component for calculating variable odds. The apparatus may randomly select a number of game results and generate variable odds for each of these game results. The variable odds are then displayed on an electronic display panel, and for bets that have placed on the corresponding game results, a payout component pays the players based on the payout odds or the variable odds. Accordingly, the incentive apparatus increases a Return to Player (RTP) rate to increase utilization of the gambling game system.

However, traditional incentives for increased payouts (by increasing the RTP rate) sacrifice the operating profit of the game dealer. For the game dealer, a higher RTP rate can increase turnover, but it is unfavorable to operating profit. In practice, limiting the RTP rate to meet an acceptable operating profit, a maximum numerical value of the variable odds of additional stakes still may be too small to produce the effect of attracting players.

In addition, when a gaming machine does not use a physical game result generating unit, such as physical playing cards, dice, or a physical roulette wheel, players may experience a lack of immersion in the gameplay. When the gaming machine uses a virtual random number generator as the game result generating unit, even if it has been certified by official authorities to enhance credibility, prolonged gameplay can lead to doubts about the system's fairness if the expected results are not achieved. When the players suspect the game may be unfair, their interest in playing significantly decreases.

Furthermore, players engaging in remote gaming can only monitor the physical game result generating unit through an additional display screen (e.g., through online live streaming). Accordingly, remote players must pay attention to both the electronic display panel containing the variable odds and the screen displaying the physical game result generating unit to keep track of real-time betting information and game results. As a result, remote players are often distracted by having to simultaneously view both the live stream screen and the gaming machine's display panel. This can be mentally exhausting and lead to shorter gaming sessions and decreased turnover.

### SUMMARY OF THE INVENTION

The present invention comprises game systems and methods for providing variable odds. In a preferred embodiment, a variable odds mechanism is designed to provide sufficient incentives to attract players while minimizing any significant change to the Return to Player (RTP) rate.

Another feature of the present invention includes game systems and methods comprising an image synthesis display, in which an image synthesized from a real-time image and betting data and/or a set of adjusted payout odds to create a synthesized image displayed by a display unit. This allows the players to simultaneously view a real-time image of the physical game result generating unit and keep track of the betting data and variable odds, thereby enhancing the sense of immersion and reducing mental burden during gameplay.

In some embodiments, the disclosure relates to game systems. In one instance, a game system is provided in which a player plays at least one round of a gambling game. The gambling game includes a plurality of game results and corresponding payout odds for each result. For each round of the gambling game, each of the plurality of game results includes a probability of occurrence, and a Return to Player (RTP) rate of the gambling game is calculated according to the probability of occurrence and the payout odds.

A preferred game system includes a display unit, an input unit, an odds processing unit, a physical game result generating unit, a payout unit, an image capturing unit, an image recognition unit, an image synthesis processing unit, and/or a game processing unit.

In some embodiments, the game processing unit controls an operation of the gambling game for proceeding through at least one round of the gambling game. The display unit is connected to the game processing unit and displays a game screen of the gambling game. The game screen includes a plurality of betting areas corresponding to the plurality of game results. The input unit is connected to the game processing unit and receives a bet from the player on the plurality of betting areas in a betting time to generate betting data. The betting data are transmitted to the game processing unit.

The odds processing unit is connected to the game processing unit and generates at least one set of variable odds corresponding to at least one of the plurality of payout odds. Each set of variable odds includes odds which replace the corresponding payout odds when selected. Each of the variable odds has a selection probability. Accordingly, the odds processing unit selects one of the variable odds, according to its selection probability, to replace the corresponding payout odds to generate a set of adjusted payout odds for the gambling game. The display unit displays the set of adjusted payout odds in the corresponding betting areas.

In some embodiments, the set of variable odds meets a plurality of requirements. Namely, (1) that number of variable odds is greater than two, (2) that numerical values of some of the variable odds are lower than numerical values of the corresponding payout odds; and (3) that an RTP rate calculated based on the numerical values and the selection probability of the variable odds may be made to meet a specified condition.

In addition, the physical game result generating unit is connected to the game processing unit. The physical game result generating unit randomly generates one of the plurality of game results in each round of the gambling game as a round result thereof. The payout unit is connected to the game processing unit and pays out according to the betting data, the round result and the set of adjusted payout odds.

The image capturing unit is connected to the game processing unit and captures a real-time image by, for example, photographing a real scene of the physical game result generating unit. The image capturing unit transmits the real-time image to the game processing unit.

The image recognition unit is connected to the game processing unit, receives the real-time image from the game processing unit, and analyzes and recognizes a position of the real-time image to generate location information. The image recognition unit transmits the location information back to the game processing unit.

The image synthesis processing unit is connected to the game processing unit and receives the real-time image, the location information, the betting data, and the set of adjusted payout odds from the game processing unit. The image synthesis processing unit generates a synthesized image based on at least one of the real-time image, the location information, the betting data, and the set of adjusted payout odds received, and transmits the synthesized image to the game processing unit. The display unit displays the synthesized image transmitted by the game processing unit.

In another embodiment, the odds processing unit provides a plurality of odds tables for selection by the player. The selected odds table is further processed/applied. Each of the plurality of odds tables includes a set of variable odds corresponding to the payout odds, each of the sets of variable odds includes a plurality of variable odds for replacing the corresponding payout odds (if selected), and each of the variable odds has a selection probability. In each of the sets of variable odds of the applied odds table, according to the selection probability, the odds processing unit selects one of the plurality of variable odds to replace the corresponding payout odds to generate a set of adjusted payout odds. In these embodiments, the display unit displays the set of adjusted payout odds in the corresponding betting area.

Each of the plurality of odds tables separately meets a plurality of requirements. Namely, (1) that numerical values of some of the variable odds in each of the sets of variable odds of each of the odds tables are lower than numerical values of the corresponding payout odds, and (2) that an RTP rate calculated based on the numerical values and the selection probability of the variable odds may be made to meet a specified condition.

In another embodiment, the odds processing unit groups the plurality of payout odds into at least one set according to the numerical values thereof, and then provides at least one corresponding set of variable odds for the at least one set. The player selects a set of variable odds, and the selected set is further processed/applied. Each set of variable odds includes a variable odd for selecting and replacing the corresponding payout odds, and each of the variable odds has a selection probability. After the set of variable odds is selected, the odds processing unit, according to the selection probability, selects one of the variable odds to replace the corresponding one of the set of payout odds to generate a set of adjusted payout odds for the gambling game. The display unit displays the set of adjusted payout odds in the corresponding betting area.

Each set of variable odds separately meets a plurality of requirements. Namely, (1) that numerical values of some of the variable odds of each set of variable odds are lower than the corresponding payout odds, and (2) an RTP rate calculated based on the numerical values and the selection probability of the variable odds may be made to meet a specified condition.

In addition, the present invention also provides methods for using any of the game systems described above. In one embodiment, preferred methods provide for a player to play at least one round of a gambling game. The gambling game includes a plurality of game results and a set of payout odds. A display unit displays a game screen of the gambling game including a plurality of betting areas corresponding to the plurality of game results. The set of payout odds includes a plurality of payout odds corresponding to the plurality of game results. For each round of the game, each of the plurality of game results has a probability of occurrence. A Return to Player (RTP) rate of the gambling game can be calculated based on the probability of occurrence and the payout odds.

Preferred methods include a betting step, a variable odds selecting step, an odds updating step, a game result generating step, an image capturing step, an image recognition step, an image synthesis step, a synthesized image display step, and/or a payout step.

The betting step generates betting data via an input unit by the player betting on the betting areas in a betting time.

The variable odds selecting step generates at least one set of variable odds corresponding to at least one of the plurality of payout odds by an odds processing unit. The at least one set of variable odds includes at least one variable odds that, when selected, replaces the corresponding payout odds. Each of the at least one variable odds has a selection probability, and in each set of variable odds, according to the selection probability, the odds processing unit selects one of the at least one variable odds to replace the corresponding payout odds to generate a set of adjusted payout odds.

The at least one set of variable odds meets a plurality of requirements. Namely, that (1) numbers of all the variable odds are more than two, (2) numerical values of some of the variable odds are lower than numerical values of the corresponding payout odds, and (3) an RTP rate calculated based on the numerical values and selection probabilities of the variable odds may be made to meet a specified condition.

The odds updating step displays the set of adjusted payout odds on the display unit after completing the betting step and the variable odds selecting step. The game result generating step randomly generates one of the plurality of game results by a physical game result generating unit for each round of the gambling game.

The image capturing step captures a real-time image by photographing a real scene of the physical game result generating unit with an image capturing unit. The image recognition step analyzes the real-time image to recognize a position of the real-time image and generate a location information by an image recognition unit.

The image synthesis step receives the real-time image, the location information, the betting data, and the set of adjusted payout odds by an image synthesis processing unit, and generates a synthesized image based on the real-time image, the location information, and at least one of the betting data and the set of adjusted payout odds.

The synthesized image display step displays the synthesized image by the display unit. The payout step pays out according to the betting data, the round result, and the set of adjusted payout odds by a payout unit.

In another embodiment, the odds selecting step provides a plurality of odds tables from an odds processing unit. The player selects an odds table, and the selected odds table is processed/applied. Each of the plurality of odds tables includes a set of variable odds corresponding to the payout odds. Each of the sets of variable odds includes a plurality of variable odds for selection. When selected, the variable odds replace the corresponding payout odds. Each of the variable odds has a selection probability, and each of the plurality of odds tables meet a plurality of requirements. Namely, that (1) numerical values of some of the variable odds in each set of variable odds of each of the odds tables are lower than numerical values of the corresponding payout odds, and (2) an RTP rate calculated based on the numerical values and the selection probability of the variable odds may be made to meet a specified condition.

For this embodiment, in the variable odds selecting step, selecting one of the variable odds in each of the sets of variable odds of the applied odds table according to the selection probability through the odds processing unit and replacing the corresponding payout odds to generate a set of adjusted payout odds for the gambling game.

In another embodiment, the odds selecting step groups the payout odds into at least one set according to numerical values thereof. The at least one set relates to a corresponding set of variable odds for the player to select from. One of the corresponding sets of variable odds is processed/applied by the odds processing unit.

Each set of variable odds includes a variable odd for replacing the corresponding payout odds, if selected. Each of the variable odds has a selection probability, and each set of variable odds separately meets a plurality of requirements. Namely, (1) that numerical values of some of the variable odds of each of the sets of variable odds are lower than the corresponding payout odds, and (2) an RTP rate calculated based on the numerical values and selection probabilities of the variable odds may be made to meet a specified condition

In the variable odds selecting step, selecting one of the variable odds according to the selection probability through the odds processing unit, after applying the selected set of variable odds, and replacing the at least one payout odds of a same set respectively to generate a set of adjusted payout odds for the gambling game.

Accordingly, the present invention incudes the game system for providing displaying variable odds through a synthetic image and methods of performing the same. The variable odds increase the numerical value of some of the payout odds and reducing the others of the payout odds. Therefore, the present invention generates a numerical value and selection probability of the variable odds sufficient to attract the player while making minimal changes to the RTP rate. At the same time, the present invention seeks to create the demand for attracting the player and to maintain the operating profit.

Further, the display unit of the present invention displays a synthesized image overlaying information on the real-time image including the betting data, and/or the set of adjusted payout odds. The real-time image is a real scene of the physical game result generating unit, and the real-time image is synthesized with the betting data, and numeral values of the set of adjusted payout odds for accurate display according to the location information. Through the synthesized image, the player is able to keep track of the betting data and the numeric values of the set of adjusted payout odds, creating an immersive experience that satisfies the enjoyment of participating in a live game and reducing the mental burden during gameplay.

### BRIEF DESCRIPTION OF THE DRAWINGS

FIG. 1 is a system architecture diagram according to one or more embodiment of the present invention;

FIG. 2 is a flowchart of steps of a method according to one or more embodiment of the present invention;

FIG. 3 is a schematic diagram of a physical game result generating unit according to one or more embodiment of the present invention.

FIGS. 4A, 4B, and 4C are schematic diagrams of a betting table according to one or more embodiment of the present invention;

FIG. 5 is a flowchart of method steps according to one or more embodiment of the present invention;

FIGS. 6A and 6B are schematic diagrams of a betting table according to one or more embodiment of the present invention;

FIGS. 7A and 7B are schematic diagrams of a betting table according to one or more embodiment of the present invention; and

FIG. 8 is the other system architecture diagram according to one or more embodiment of the present invention.

The detailed description and technical contents of the present invention are described below with reference to the drawings.

### DETAILED DESCRIPTION

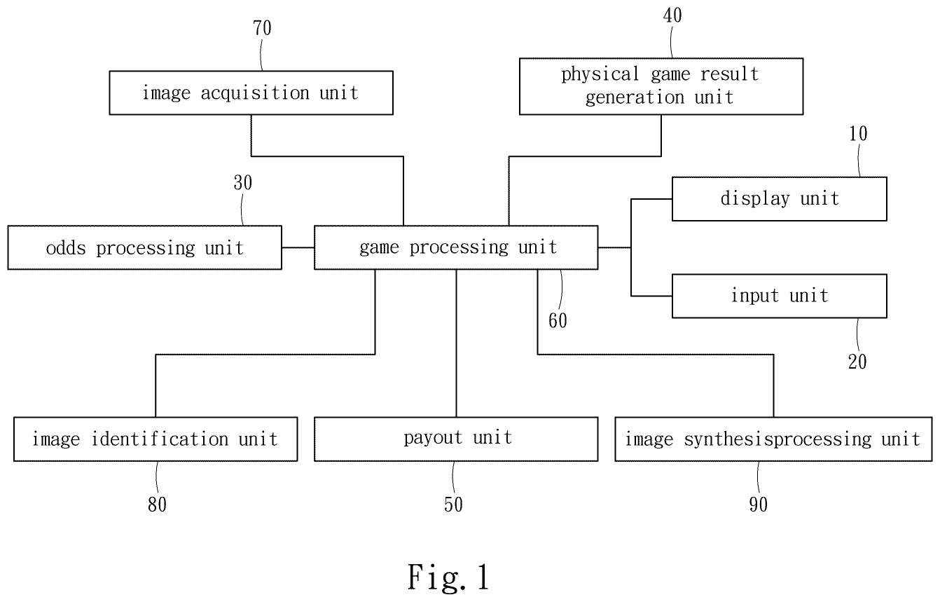

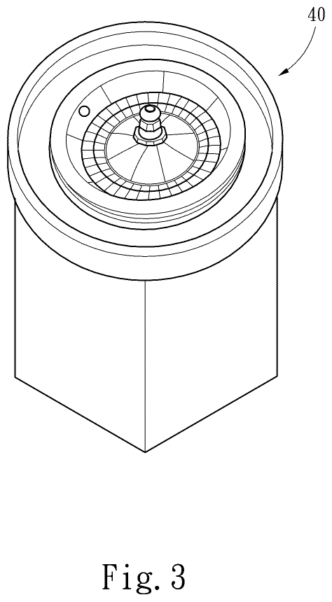

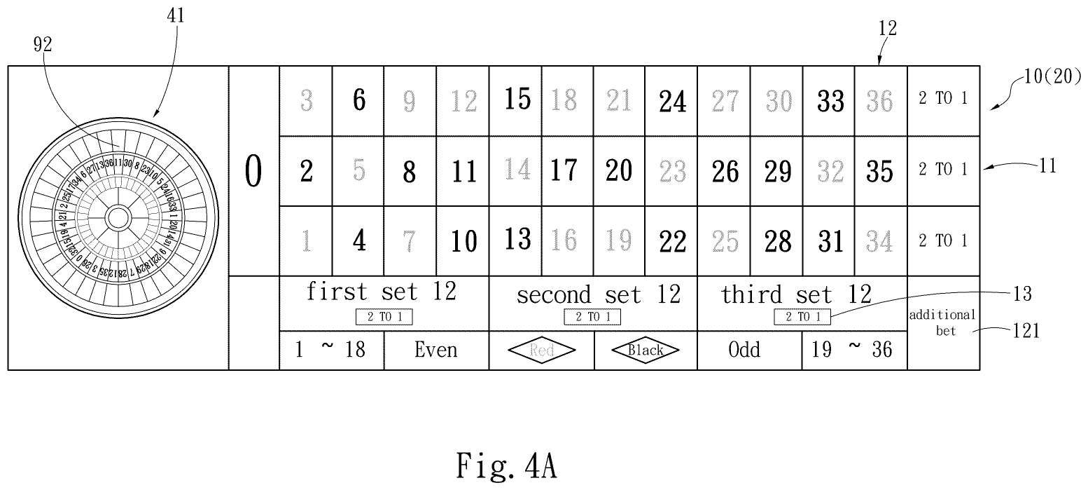

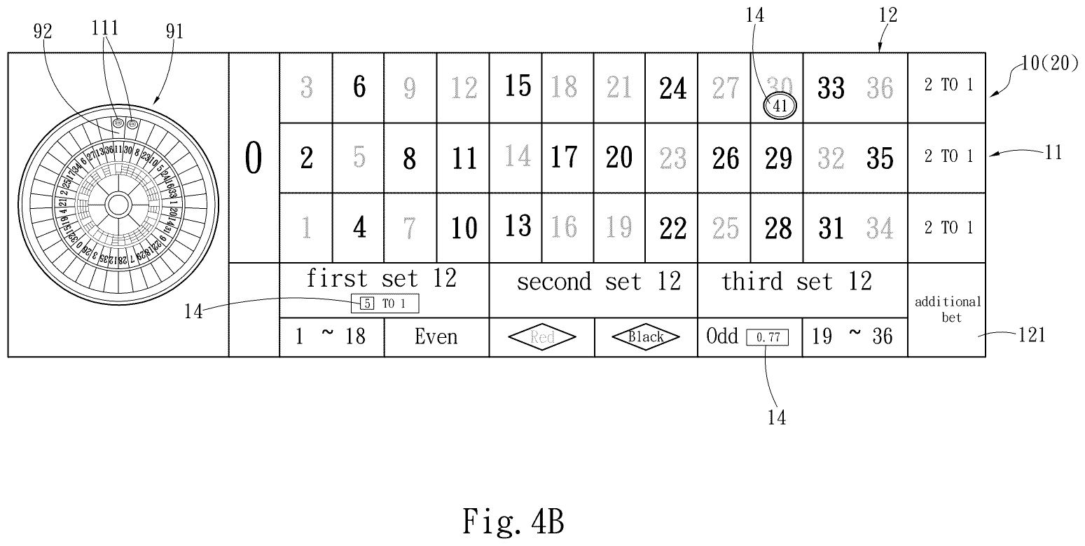

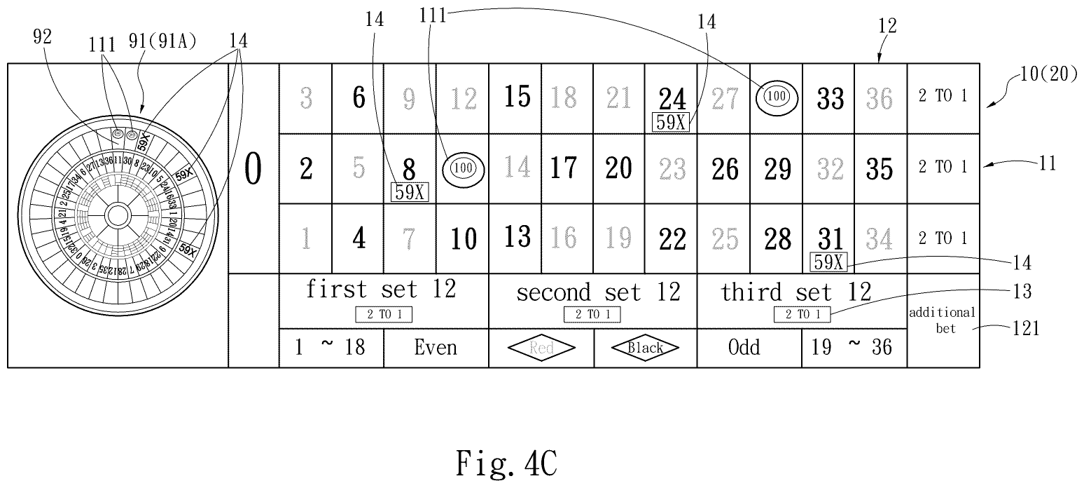

Referring to FIGS. 1-4B, a game system for providing variable odds is described according to a first embodiment of the present invention. The game system is provided for a player to play at least one round of a gambling game. The gambling game includes a plurality of game results and a set of payout odds. The set of payout odds includes a plurality of payout odds 13 corresponding to the plurality of game results. The gambling game may include: roulette game, Sic Bo (dices) game, baccarat game, or others. In the first embodiment, a roulette game is used as an example for explanation. The set of payout odds shown in Table 1 (only listed some as representatives). The first column lists the plurality of game results, and the second column lists the plurality of payout odds 13. The plurality of payout odds 13 is shown in FIG. 4A (only indicated parts) and the payout odds 13 is the most widely used basic odds for roulette games.

TABLE 1

| Representative Roulette Payout Odds | | |
|---|---|---|
| Game results | | Payout odds |
| Numerals | 1~36 | 35 |
| Sets | 1~12 (First set) | 2 |
| | 13~24 (Second set) | |
| | 25~36 (Third set) | |
| Odd | 1, 3 . . . 35 | 1 |
| Even | 2, 4 . . . 36 | |

In addition, in each round of the gambling game, each of the plurality of game results has an occurrence probability. So, a Return to Player (RTP) rate of the gambling game can be calculated according to the occurrence probability and the payout odds. RTP is an average value of products of the occurrence probability of each of the game results and the corresponding payout odds.

As shown in FIG. 1, the game system may include a display unit 10, an input unit 20, an odds processing unit 30, a physical game result generating unit 40, a payout unit 50, a game processing unit 60, an image capturing unit 70, an image recognition unit 80, and/or an image synthesis processing unit 90. The game processing unit 60 is connected to the display unit 10, the input unit 20, the odds processing unit 30, the physical game result generating unit 40 and the payout unit 50, the game processing unit 60, an image capturing unit 70, an image recognition unit 80, an image synthesis processing unit 90, and the game processing unit 60 controls operation of the gambling game to perform the at least one round of the gambling game.

Referring to FIG. 4A, the display unit 10 displays a game screen 11 of the gambling game. The game screen 11 includes a plurality of betting areas 12 corresponding to the plurality of game results. In one embodiment, the input unit 20 is integrated with the display unit 10, and the input unit 20 is a touch display screen that provides both input and display functions for the player to bet on the betting areas 12 in a betting time to generate betting data, and the input unit 20 transmits the betting data to the game processing unit 60.

Referring to FIG. 4A and FIG. 4B, the odds processing unit 30 generates at least one set of variable odds corresponding to at least one of the plurality of payout odds 13 (as shown in FIG. 4A). The at least one set of variable odds has at least one selected variable odds 14 for replacing the corresponding payout odds 13, and each of the variable odds 14 has a selection probability.

Table 2 provides one embodiment of the at least one set of variable odds. The columns represent the corresponding payout odds 13 of the game results, the corresponding set of variable odds (including the at least one variable odds 14) and the selected probabilities corresponding to each of the variable odds 14.

TABLE 2
Payout Odds and Variable Odds

| | | Payout | Sets of | Selection |
|---|---|---|---|---|
| Game results | | odds | Variable Odds | probabilities |
| Numeral | 30 | 35 | (27, 41, 101, 168) | (83%, 10%, 5%, 2%) |
| First set | 1~12 | 2 | (1, 5) | (75%, 25%) |
| Odd | 1, 3 ... 35 | 1 | (0.77, 3) | (90%, 10%) |

In addition, the at least one set of variable odds meets the following conditions: the number of the variable odds 14 in all sets of variable odds is more than two; in one set of variable odds, the numerical values of some of the variable odds 14 are lower than the numerical values of the corresponding payout odds 13; and the numerical values of the others of the variable odds 14 are calculated according to a variable value of the RTP rate which is made to meet a specified condition. The specified condition is selected according to actual needs. Preferably, the specified condition is that the variable value of the RTP rate is a minimum.

The variable value is a difference between numerical values of the RTP rate before and after changing the payout odds and then takes the absolute value. That is, the less variation (including increase and decrease) of the RTP rate the better. Ideally, in order to maintain the operating profit, the variable value of the RTP rate being zero is the most ideal state. However, in actual calculations, there is a problem of being impossible to be divided with no remainder, so in practice, keeping the variable value of the RTP rate to a minimum is preferred. In other embodiments, the specified condition is that the RTP rate increases or decreases by a specified value to meet business requirements.

The RTP rate of the game is obtained by first calculating the RTP rate of each set of variable odds separately and then averaging all the RTP rates. Therefore, under the premise that the variable value of the RTP rate is minimal, as long as the numerical value of some (at least one but not all) of the variable odds 14 is lower than the numerical value of the corresponding payout odds 13, numerical values of the others of variable odds 14 can be effectively increased to attract the player to play the gambling game. In addition, the numerical values of the variable odds 14 provided in the embodiments of the present invention are only exemplary values, but not actual numerical values of odds, which can be implemented by those skilled in the art based on the techniques disclosed in the present invention according to actual requirements.

After generating the at least one set of variable odds, in each of the sets of variable odds, the odds processing unit 30 selects one of the at least one variable odds 14 according to their selection probability to replace the corresponding payout odds 13 to allow the gambling game to generate a set of adjusted payout odds. One embodiment of the set of adjusted payout odds is shown in Table 3 below.

TABLE 3
Original and Adjusted Payout Odds

| Game results | | Original payout odds | Adjusted payout odds |
|---|---|---|---|
| Numeral | 30 | 35 | 41 |
| First set | 1~12 | 2 | 5 |
| Odd | 1, 3 ... 35 | 1 | 0.77 |

The display unit 10 displays the set of adjusted payout odds in the betting areas 12 (as shown in FIG. 4B).

The physical game result generating unit 40 randomly generates one of the game results in each of the rounds of the gambling game as a round result thereof. The payout unit 50 pays out according to the betting data, the round result, and the set of adjusted payout odds.

The image capturing unit 70 captures a real-time image 41 by photographing a real scene of the physical game result generating unit 40. The real-time image 41 is displayed in the game screen 11, as shown in FIG. 4A. The real-time image 41 is transmitted from the image capturing unit 70 to the game processing unit 60, and then is transmitted from the game processing unit 60 to the image recognition unit 80. The image recognition unit 80 analyzes and recognizes a position of the real-time image 41 to generate location information and transmits the location information to the game processing unit 60.

The game processing unit 60 transmits the real-time image 41, the location information, the betting data, and the set of adjusted payout odds to the image synthesis processing unit 90. A synthesized image 91 is generated by the image synthesis processing unit 90 after receiving the real-time image 41, the location information, and at least one of the betting data and the set of adjusted payout odds. The synthesized image 91 is transmitted from the image synthesis processing unit 90 to the game processing unit 60, and then is transmitted from the game processing unit 60 to the display unit 10 for display.

Furthermore, the real scene of the physical game result generating unit 40 may include a plurality of frames 92 corresponding to the plurality of betting areas 12, as shown in FIG. 4A. Accordingly, the plurality of frames 92 are included in the real-time image 41, so that the image synthesis processing unit 90 reproduces the real scene in the synthesized image 91, For example, the plurality of frames 92 are shown in FIG. 4B, and the betting data is displayed in the plurality of frames 92 of the synthesized image 91.

In another embodiment, when the betting data changes during the betting time, the image synthesis processing unit 90 generates the synthesized image 91 based on a latest betting data, that is, the plurality of frames 92 of the synthesized image 91 always display the latest betting data.

In yet embodiment, the image synthesis processing unit 90 generates the synthesized image 91 after receiving the real-time image 41, the location information, the betting data, and the set of adjusted payout odds, thereby reducing a computation burden of the image synthesis processing unit 90.

Referring to FIG. 1 and FIG. 4B together, the location information recognizes a position of the real-time image 41. Therefore, when the image synthesis processing unit 90 receives the real-time image 41, the location information, the betting data, and the set of adjusted payout odds, at least one chip 111, corresponding to the betting data, is overlaid onto the real-time image 41 by the image synthesis processing unit 90 to generate the synthesized image 91. The synthesized image 91 includes the real-time image 41 (i.e., the real scene of the physical game result generating unit 40) and the betting data, wherein a player's betting data is displayed in an image form of the at least one chip 111.

Referring to FIG. 1 and FIG. 4C together, in one embodiment, an example of the set of adjusted payout odds is shown in Table 4 below. In this example, 59× represents a 59-fold payout.

TABLE 4
Set of Adjusted Payout Odds

| Game result | The adjusted payout odds |
|---|---|
| Single number 8, 24, 31 | 59× |

When the image synthesis processing unit 90 receives the real-time image 41, the location information, the betting data, and the set of adjusted payout odds, the image synthesis processing unit 90 generates the other synthesized image 91A based on the real-time image 41 (as shown in FIG. 4A), the location information, the betting data, and the set of adjusted payout odds received. Likewise, the image synthesis processing unit 90 reproduces the real scene in the other synthesized image 91A, and the at least one variable odds 14 (i.e., the adjusted payout odds) is displayed in the plurality of frames 92 of the synthesized image 91. In actual implementation, the virtual-real synthesized images 91, 91A can be overlaid and displayed, namely, both the variable odds 14 and the betting data (such as a distribution of the at least one chip 111) can be shown simultaneously on a single screen, as shown in FIG. 4C.

In addition, in order to meet the demands of the player, the input unit 20 allows the player to selectively input at least one of the upper limit value, the lower limit value, or the amount of the at least one variable odds 14, and then allows the odds processing unit 30 to generate the at least one set of variable odds accordingly.

For example, the player selectively inputs an upper limit value, a lower limit value, or amount of the variable odds 14 that can be accepted according to preference, and the odds processing unit 30 will generate the at least one set of variable odds based on the player's input. Therefore, the player can obtain different variable odds 14 in each of the rounds of the gambling game to maintain excitement.

In practice, the odds processing unit 30 generates the at least one set of variable odds by a mathematical trial and error method. In detail, the odds processing unit 30 first randomly generates the variable odds 14 of the at least one set of variable odds, including the amount, the numerical value, and the selection probability, under the premise of meeting the player's input conditions. Then the odds processing unit 30 calculates the RTP rate to determine whether the variable value of the RTP rate is positive or negative. When the variable value of the RTP rate is positive, it represents that the numerical value of the variable odds 14 is too high, and the odds processing unit 30 will decrease the numerical value by adjusting with minimum unit and recalculate the RTP rate until the variable value of the RTP rate is changed to a negative number. As the variable value of the RTP rate converges, the odds processing unit 30 selects a minimal absolute value of the variable value of the RTP rate as the last set of variable odds to meet the specified condition.

In addition, the game processing unit 60 further determines whether to allow the odds processing unit 30 to generate the at least one set of variable odds according to a preset condition. In detail, the preset condition may be set by the player or operator, or may be used as a bonus in the gambling game, or only when a bet amount of the player exceeds a specified numerical value. The odds processing unit 30 generates the at least one set of variable odds. Alternatively, an additional betting option 121 is provided in the betting area 12, and only when the player bets on the additional betting option 121, the odds processing unit 30 generates the at least one set of variable odds.

While the system architecture diagram of FIG. 1 illustrates all of the units in communication with the game processing unit 60, in some embodiments, the units are directly connected to each other. For example, the image acquisition unit 70 may be directly connected to the image identification unit 80 without transmission through a game processing unit 60.

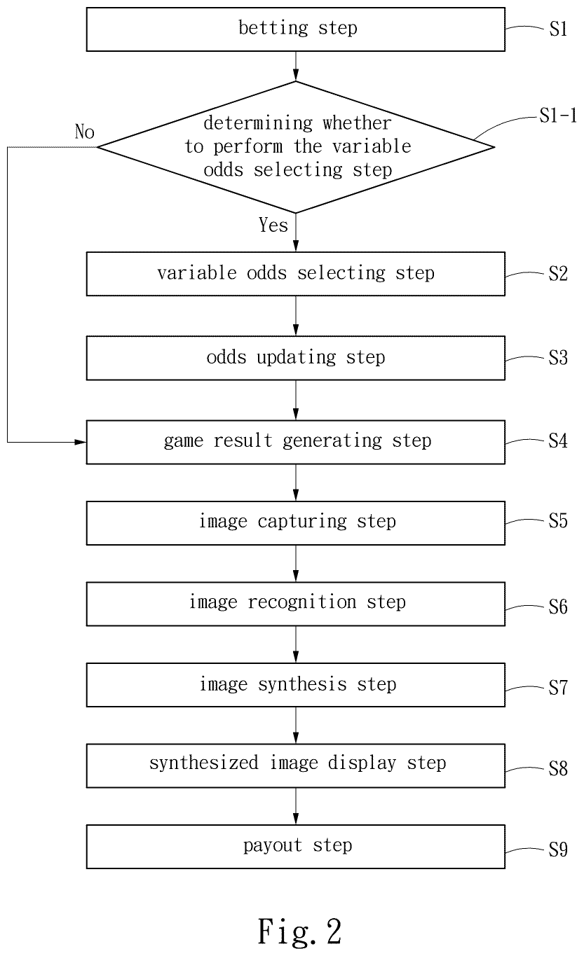

FIG. 2 is a flowchart of steps of a method according to one or more embodiment. The steps of the illustrated method include: step S1: a betting step, step S2: a variable odds selecting step, step S3: an odds updating step, step S4: a game result generating step, step S5: an image capturing step, step S6: an image recognition step, step S7: an image synthesis step, step S8: a synthesized image display step, and step S9: a payout step. Each step is discussed in detail below.

Step S1: the betting step or input step. This step generates the betting data by allowing a player to bet on the betting areas 12. Step S1-1 may be performed thereafter. Step S1-1: determining whether to perform the variable odds selecting step. Namely, the game processing unit 60 determines whether to allow the odds processing unit 30 to generate the at least one set of variable odds, that is determining whether to perform the variable odds selecting step S2. If so, the method continues to the variable odds selecting step S2; if not, the method proceeds directly to the game result generating step S4.

Step S2: the variable odds selecting step. At least one set of variable odds is generated by the odds processing unit 30. Then, one of the at least one variable odds 14 is selected according to a selection probability to replace the corresponding payout odds 13. The odds processing unit 30 generates the set of adjusted payout odds for the gambling game.

Step S3: the odds updating step. The set of adjusted payout odds is displayed on the display unit 10 after completing the betting step S1 and the variable odds selecting step S2, as shown in FIG. 4B.

Step S4: the game result generating step. The round result is generated by the game result generating unit 40.

Step S5: an image capturing step. A real-time image is captured by photographing a real scene of the physical game result generating unit 40 by the image capturing unit 70.

Step S6: an image recognition step. A position of the real-time image 41 is analyzed by the image recognition unit 80 to generate location information.

Step S7: an image synthesis step. The real-time image 41, the location information, the betting data, and the set of adjusted payout odds is received by the image synthesis processing unit 90. The image synthesis processing unit 90 generates a synthesized image 91 based on the real-time image, the location information, and at least one of the betting data, and the set of adjusted payout odds received by the image synthesis processing unit 90.

Step S8: a synthesized image display step. The synthesized image 91 is displayed by the display unit 10 after the synthesized image 91 is generated.

Step S9: the payout step. The payout unit 50 pays out according to the betting data, the round result, and the set of adjusted payout odds.

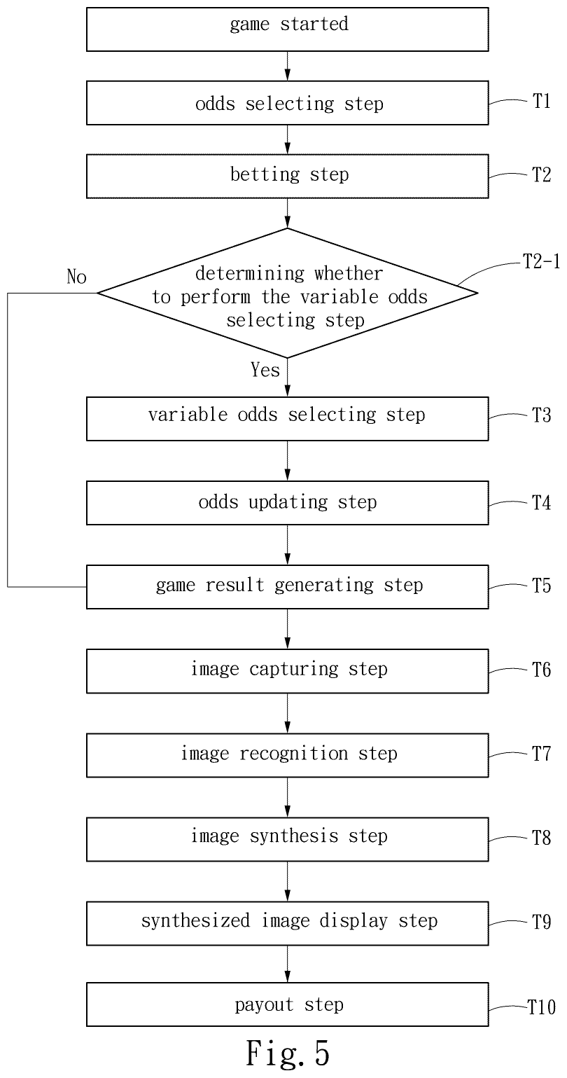

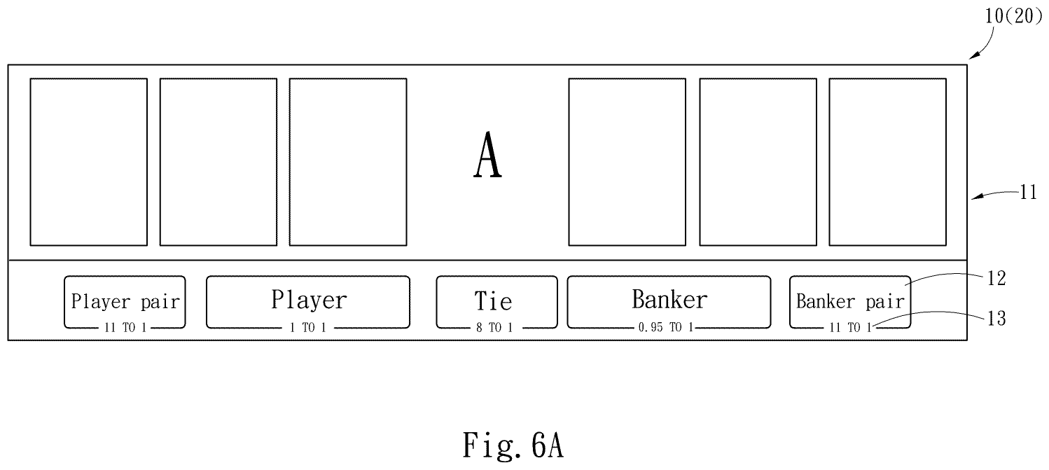

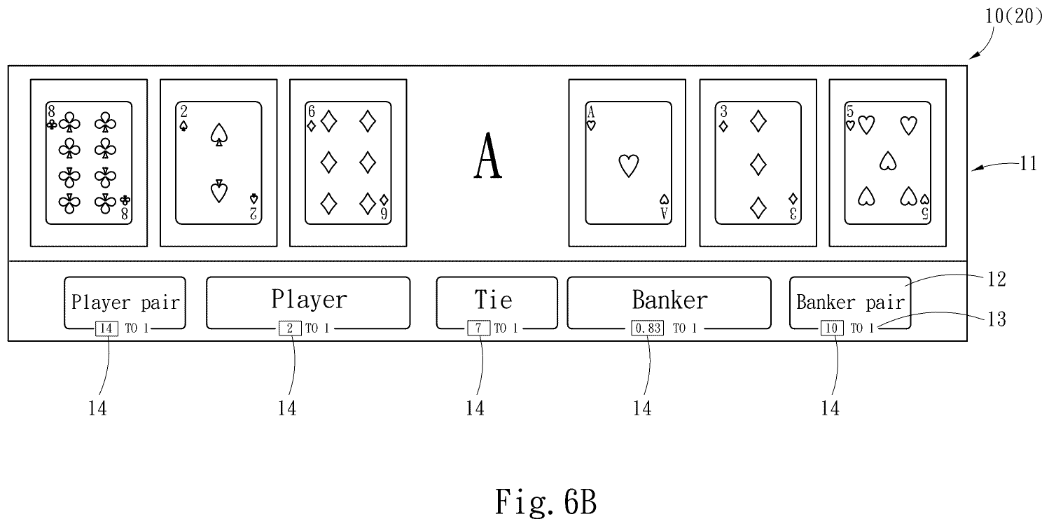

An additional embodiment is described with reference to FIG. 1, FIG. 5, FIG. 6A and FIG. 6B. This embodiment uses a baccarat game as an example for explanation, which has different procedure steps from a roulette game. The corresponding set of payout odds thereof is shown in Table 5. The first column lists the game results, and the second column lists the plurality of payout odds 13. The plurality of payout odds 13 is shown in FIG. 6A.

TABLE 5

| Baccarat Outcomes with Payout Odds | |
|---|---|
| Game results | Payout odds |
| Banker | 0.95 |
| Player | 1 |
| Tie | 8 |
| Banker pair | 11 |
| Player pair | 11 |

Compared with roulette, the odds processing unit 30 of provides a plurality of odds tables for embodiments related to baccarat.

An embodiment of the odds tables is shown below:

TABLE 6
An Exemplary Odds Table

| | Game | Payout | Sets of Variable Odds | Selected |
|---|---|---|---|---|
| Tables | results | odds | (Variable Odds) | Probabilities |
| Table | Banker | 0.95 | (0.83, 2) | (90%, 10%) |
| A | Player | 1 | (0.88, 2) | (90%, 10%) |
| | Tie | 8 | (7, 8, 10) | (50%, 30%, 20%) |
| | Banker pair | 11 | (10, 11, 14) | (50%, 35%, 15%) |
| | Player pair | 11 | (10, 11, 14) | (50%, 35%, 15%) |
| Table | Banker | 0.95 | (0.85, 2) | (92%, 8%) |
| B | Player | 1 | (0.9, 2) | (92%, 8%) |
| | Tie | 8 | (6, 9, 12) | (50%, 35%, 15%) |
| | Banker pair | 11 | (9, 12, 15) | (50%, 35%, 15%) |
| | Player pair | 11 | (9, 12, 15) | (50%, 35%, 15%) |
| Table | Banker | 0.95 | (0.8, 3) | (94%, 6%) |
| C | Player | 1 | (0.85, 3) | (94%, 6%) |
| | Tie | 8 | (6, 8, 20) | (60%, 30%, 10%) |
| | Banker pair | 11 | (8, 10, 30) | (60%, 30%, 10%) |
| | Player pair | 11 | (8, 10, 30) | (60%, 30%, 10%) |

The player selects one of the odds tables, that is, chooses any one of Table A, Table B, or Table C. The odds tables respectively record the sets of variable odds corresponding to the payout odds 13.

In addition, each of the odds tables separately meets the following conditions: in each of the odds tables, the numerical values of some of the variable odds 14 of each set of variable odds are lower than the numerical values of the corresponding payout odds 13; and a variable value of the RTP rate calculated based on the numerical values of the variable odds and their selection probabilities may be made to meet a specified condition (as described above).

The plurality of sets of variable odds includes at least one variable odds 14 for selection to replace the corresponding payout odds 13. Each of the at least one variable odds 14 has a selection probability. In addition, the odds processing unit 30 further provides a basic odds table. The basic odds table records the payout odds 13 and is included for the player to play the gambling game without variable odds.

In each of the sets of variable odds of the selected odds table, the odds processing unit 30 selects one of the variable odds 14 according to the selection probabilities to replace the corresponding payout odds 13 to allow the gambling game to generate a set of adjusted payout odds. For example, if Table A is selected, one embodiment of the set of adjusted payout odds is shown in Table 7.

TABLE 7
Set of Adjusted Payout Odds based on Table A

| Game results | Original payout odds | Adjusted payout odds |
|---|---|---|
| Banker | 0.95 | 0.83 |
| Player | 1 | 2 |
| Tie | 8 | 7 |
| Banker pair | 11 | 10 |
| Player pair | 11 | 14 |

The display unit 10 displays the set of adjusted payout odds in the betting area 12 (as shown in FIG. 6B).

FIG. 5 is a flowchart corresponding to a method which utilizes the odds tables described above. The steps of the method may include: step T1: an odds selecting step, step T2: a betting step, step T3: a variable odds selecting step, step T4: an odds updating step, step T5: a game result generating step, and step T10: a payout step.

Compared with the methods disclosed elsewhere herein, these methods first perform step T1: the odds selecting step. The plurality of odds tables are provided via the odds processing unit 30 for the player to select any one of the plurality of odds tables. The selected odds table is then further processed/applied.

Step T2: the betting step. The betting data is generated by the input unit 20 as a result of the player betting on the betting areas 12. A step T2-1 is alternatively performed after step T2. Step T2-1 determines whether to perform the variable odds selecting step. If determining to select the variable odds 14, the method continues to step T3: the variable odds selecting step. If determining not to select the variable odds 14, the method proceeds directly to step T5: the game result generating step.

Step T3: the variable odds selecting step. One of the at least one variable odds 14 is selected according to a selection probability through the odds processing unit 30 to replace the corresponding payout odds 13. The odds processing unit 30 generates the set of adjusted payout odds for the gambling game based on the selected variable odds 14.

Step T4: the odds updating step. The set of adjusted payout odds is displayed in the betting area 12 on the display unit 10 after completing the betting step T2 and the variable odds selecting step T3, as shown in FIG. 6B.

Step T5: the game result generating step. The round result is generated by the physical game result generating unit 40.

Step T6: an image capturing step. A real-time image is captured by photographing a real scene of the physical game result generating unit 40 by the image capturing unit 70.

Step T7: an image recognition step. A position of the real-time image 41 is analyzed by the image recognition unit 80 to generate a location information.

Step T8: an image synthesis step. The real-time image 41, the location information, the betting data, and the set of adjusted payout odds are received by the image synthesis processing unit 90. The image synthesis processing unit 90 generates a synthesized image 91 based on the real-time image, the location information, and one or more of the betting data, and the set of adjusted payout odds.

Step T9: a synthesized image display step. The synthesized image 91 is displayed by the display unit 10 after the synthesized image 91 is generated.

Finally, step T10: the payout step. The payout unit 50 pays out according to the betting data, the round result, and the set of adjusted payout odds.

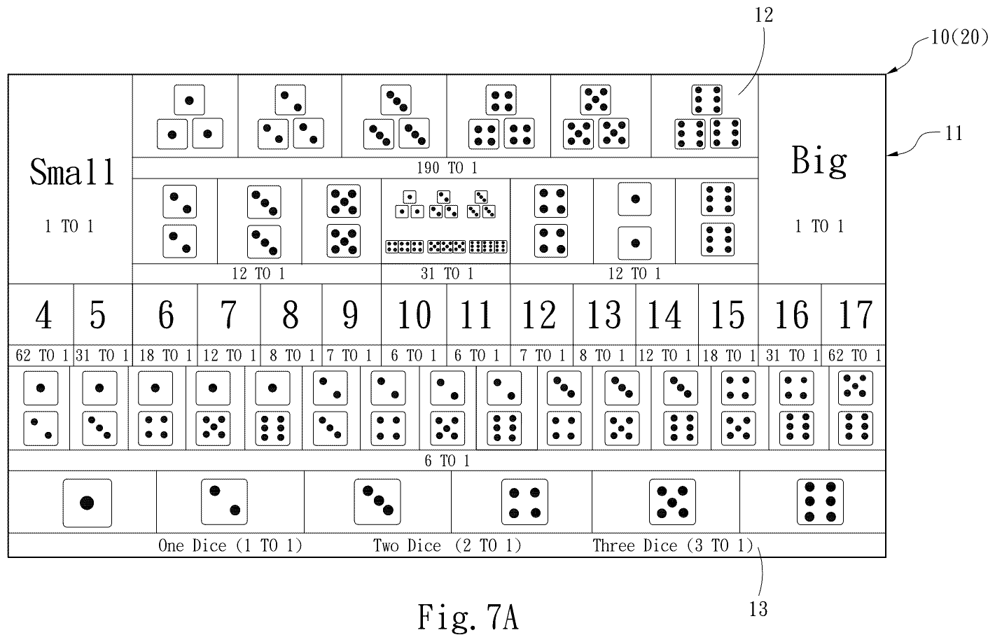

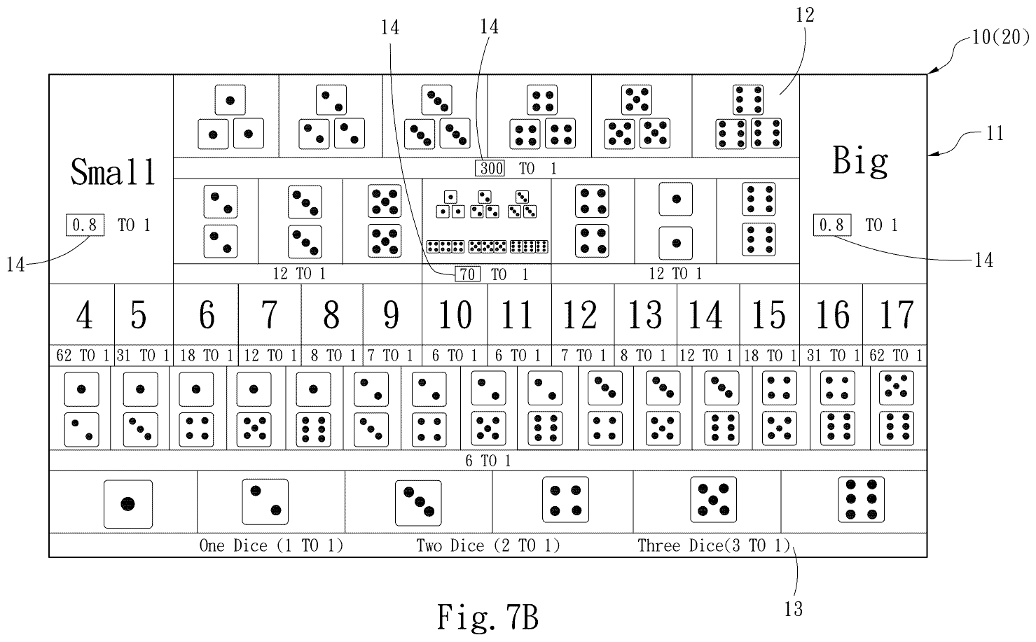

An additional embodiment is described with reference to FIG. 1, FIG. 5, FIG. 7A and FIG. 7B. This embodiment takes the SicBo game as an example for explanation. The corresponding set of payout odds is shown in Table 8 (only listed some as representatives). The first column lists the game results, and the second column lists the payout odds 13. The payout odds 13 are shown in FIG. 7A.

TABLE 8

| Exemplary Payout Odds for SicBo | |
|---|---|
| Game results | Payout odds |
| Big | 1 |
| Small | 1 |
| One Dice | 1 |
| Two Dice | 2 |
| Three Dice | 3 |
| Triple | 190 |

Compared with the previous embodiment, the odds processing unit 30 of this embodiment groups the payout odds 13 according to the numerical values, that is the game results with a same numerical value are regarded as a same set. The odds processing unit 30 selects at least one set to provide for the corresponding sets of variable odds. The player selects one of the corresponding sets of variable odds for each set of the payout odds 13. The sets of variable odds include the plurality of variable odds 14 for selection to replace the corresponding payout odds 13, and each of the variable odds 14 has a selection probability.

One embodiment of grouping by the numerical values is shown below in Table 9:

TABLE 9
Grouping of Game Outcomes by Payout Odds

| Game results | | | |
|---|---|---|---|
| (grouped by sets) | Payout odds | Sets of Variable odds | Selected Probabilities |
| Big or Small | 1 | (0.8, 3) | (91%, 9%) |
| Any Triple | 31 | (25, 70) | (87%, 13%) |
| Triple | 190 | (150, 300) | (74%, 26%) |

After the selecting the set of variable odds, the odds processing unit 30 selects one of the variable odds 14 according to their selection probability to replace the at least one payout odds 13 of the same set to allow the gambling game to generate a set of adjusted payout odds.

One embodiment of the set of adjusted payout odds is shown below in Table 10:

TABLE 10
Adjusted Payout Odds by Grouped Game Outcome

| Game results (grouped by sets) | Original payout odds | Adjusted payout odds |
|---|---|---|
| Big or Small | 1 | 0.8 |
| Any Triple | 31 | 70 |
| Triple | 190 | 300 |

The display unit 10 displays the set of adjusted payout odds in the betting area 12 (as shown in FIG. 7B).

In addition, each of the sets of variable odds separately meets the following conditions: (1) the numerical values of parts of the variable odds 14 of each set variable odds are lower than the numerical values of the corresponding payout odds 13; and (2) the numerical values of the variable odds 14 and their selection probabilities are selected based on a variable value of the RTP rate which is made to meet a specified condition.

The flowchart of FIG. 5 also corresponds to the SicBo embodiment described above.

Different from the previous embodiment, step T1: the odds selecting step. The payout odds 13 are grouped according to the numerical values and at least one set is selected via the odds processing unit 30 to provide the corresponding sets of variable odds. The player selects any one of the corresponding sets of variable odds for each set of the payout odds 13. A quantity of the sets for the player selected is freely determined, and there is no certain limit.

Step T3: the variable odds selecting step. One of the variable odds 14 is selected according to a selection probability through the odds processing unit 30 to replace the corresponding payout odds 13. The odds processing unit 30 generates the set of adjusted payout odds for the gambling game.

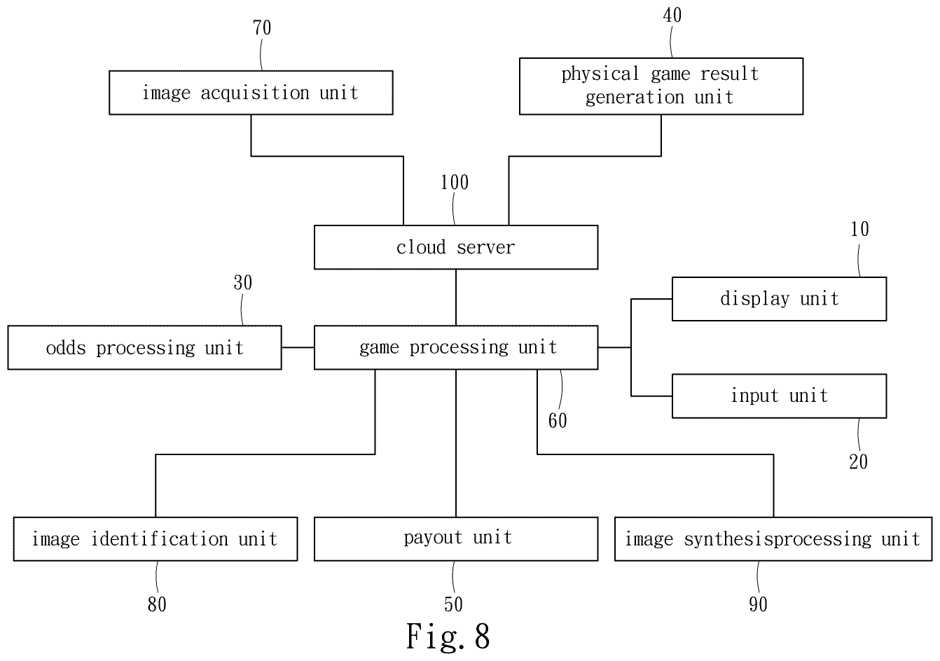

Referring to FIG. 8, the present invention further includes a cloud server 100. The physical game result generating unit 40 and the image capturing unit 70 are remotely connected to the game processing unit 60 via the cloud server 100. In other words, a plurality of game processing units 60 connect to the physical game result generation unit 40 through the cloud server 100. As a result, a high-cost physical game result generation unit 40 only needs to be set up once, and can serve the plurality of game processing units 60 (i.e., game hardware machines) located in different places through the cloud server 100. Many players can play remotely at the same time, participating in the same game result generated by the physical game result generation unit 40. This is expected to reduces setup costs and also provide an entertainment effect of shared enjoyment among the players.

In summary, the advantages of the present invention include, at least:

1. The present invention increases the numerical value of some of the variable odds by reducing others. Therefore, the present invention can generate the numerical value of the variable odds sufficient to attract the player while providing only a minimum change in the Return to Player (RTP) rate. At the same time the invention is able to meet the demand for attracting the player and to maintain the operating profit.

2. The player can select any one of the odds tables. The different odds tables include different sets of variable odds with different numerical values, so the player can select to play the gambling game according to their own preferences.

3. The odds processing unit groups the payout odds according to the numerical values and selects at least one set to provide for the corresponding sets of variable odds. The player can select any one of the provided sets of variable odds for at least one of the sets of the payout odds to meet the demand of generating the variable odds for parts of the game results.

4. The specified condition is set according to demands for increasing or decreasing the RTP rate to provide more flexibility and to meet the requirements of use.

5. The player enters an upper limit value, a lower limit value, or a quantity of the variable odds to meet the personalized customization needs.

6. The game processing unit determines whether to allow the odds processing unit to generate the at least one set of variable odds according to a preset condition.

7. The synthesized image is displayed by the display unit, allowing the players to keep track of the betting data and the numeral values of the set of adjusted payout odds, creating an immersive experience that satisfies the enjoyment of participating in a live game and reducing the mental burden during gameplay.

What is claimed is:

1. A game system comprising:
an imaging unit configured to obtain a real-time image of a gambling game;
an image synthesis processing unit configured to generate a synthesized image by combining the real-time image from the imaging unit with betting data associated with the gambling game and a set of adjusted payout odds; and
a display unit configured to display the synthesized image from the image synthesis processing unit.

2. The game system of claim 1, wherein the gambling game includes a plurality of game results and a corresponding set of payout odds, each of the plurality of game results having a probability of occurrence, and a Return to Player (RTP) rate of the gambling game calculated according to the probability of occurrence and the corresponding payout odds.

3. The game system of claim 2, further comprising a game result generating unit configured to randomly generate a round result of the gambling game indicating one or more of the plurality of game results according to the probability of occurrence.

4. The game system of claim 1, wherein the real-time image of a gambling game comprises a real scene of a game result generating unit.

5. The game system of claim 4, wherein the real scene comprises a plurality of frames corresponding to a plurality of betting areas, the image synthesis processing unit reproduces the real scene in the synthesized image, and the betting data is displayed in the plurality of frames.

6. The game system of claim 1, further comprising an image recognition unit configured to analyze the real-time image from the imaging unit by recognizing a position of the real-time image to generate location information and to transmit the location information to the image synthesis processing unit.

7. The game system of claim 1, further comprising an input unit configured to allow a player to bet on a plurality of betting areas within a betting time to generate betting data.

8. The game system of claim 1, further comprising an odds processing unit configured to:
generate a plurality of variable odds, each having a selection probability; and
select one of the variable odds, based on its selection probability, to replace a corresponding payout odd to generate a set of adjusted payout odds,
wherein the plurality of variable odds meets a set of requirements including:
that values of all the variable odds are more than two;
that numerical values of some of the variable odds are lower than numerical values of the corresponding payout odd; and
that a return to player (RTP) rate calculated based on the variable odds meets a specified condition.

9. The game system of claim 8, wherein the display unit is further configured to display the set of adjusted payout odds in a betting area of the gambling game.

10. The game system of claim 8, further comprising a payout unit configured to pay out according to the betting data, a round result of the gambling game, and the set of adjusted payout odds.

11. The game system of claim 8, wherein the specified condition is that a change in RTP rate is minimized.

12. The game system of claim 8, further comprising an input unit configured to receive selective input from a player of an upper limit value, a lower limit value, or amount of the plurality of variable odds, the plurality of variable odds generated accordingly.

13. The game system of claim 12, wherein the odds processing unit generates the plurality of variable odds by a mathematical trial and error method.

14. The game system of claim 8, wherein the odds processing unit is configured to generate a plurality of odds tables, one of the plurality of odds tables being selected by a player to provide the plurality of variable odds.

15. The game system of claim 8, wherein the odds processing unit is configured to generate a plurality of sets of variable odds, one of the plurality of sets of variable odds being selected by a player to provide the plurality of variable odds.

16. The game system of claim 10, wherein the odds processing unit is configured to generate a plurality of odds tables, one of the plurality of odds tables being selected by a player to provide the plurality of variable odds.

17. The game system of claim 16, wherein one of the plurality of odds tables is a basic odds table which lists the payout odds.

18. The game system of claim 10, wherein the odds processing unit is configured to generate a plurality of sets of variable odds, one of the plurality of sets of variable odds being selected by a player to provide the plurality of variable odds.

19. A method for displaying variable odds, the method comprising:
an imaging step to provide a real-time image of a gambling game;
an image synthesis step to generate a synthesized image by combining the real-time image with betting data associated with the gambling game and a set of adjusted payout odds; and
a synthesized image display step to display the synthesized image by a display unit.

20. The method of claim 19, wherein the gambling game includes a plurality of game results and a corresponding set of payout odds, each of the plurality of game results having a probability of occurrence, and a Return to Player (RTP) rate of the gambling game calculated according to the probability of occurrence and the corresponding payout odds.

21. The method of claim 20, further comprising a game result generation step to randomly generate a round result of the gambling game indicating one or more of the plurality of game results according to the probability of occurrence.

22. The method of claim 19, wherein the real-time image of the gambling game comprises a real scene of a game result generating unit.

23. The method of claim 22, wherein the real scene comprises a plurality of frames corresponding to a plurality of betting areas, and the image synthesis step further comprises reproducing the real scene in the synthesized image, and the betting data is displayed in the plurality of frames.

24. The method of claim 19, wherein the real-time image comprises a plurality of betting areas corresponding to a plurality of game results.

25. The method of claim 19, further comprising an image recognition step to analyze the real-time image by recognizing a position of the real-time image to generate location information to be used in the image synthesis step.

26. The method of claim 19, further comprising an input step to allow a player to bet on a plurality of betting areas within a betting time to generate betting data.

27. The method of claim 26, wherein when betting data changes during the betting time, the image synthesis step generates a new synthesized image based on changed betting data.

28. The method of claim 19, further comprising an odds processing step to:
generate a plurality of variable odds, each having a selection probability; and
select one of the variable odds, based on its selection probability, to replace a corresponding payout odd to generate a set of adjusted payout odds,
wherein the plurality of variable odds meets a set of requirements including:
that values of all the variable odds are more than two;
that numerical values of some of the variable odds are lower than numerical values of the corresponding payout odd; and
that a return to player (RTP) rate calculated based on the variable odds meets a specified condition.

29. The method of claim 28, wherein the synthesized image display step further comprises displaying the set of adjusted payout odds in a betting area of the gambling game.

30. The method of claim 28, further comprising a payout step to pay out according to the betting data, a round result of the gambling game, and the set of adjusted payout odds.

31. The method of claim 28, wherein the specified condition is that a change in RTP rate is minimized.

32. The method of claim 28, further comprising an input step to receive selective input from a player of an upper limit value, a lower limit value, or amount of the plurality of variable odds, and generate the plurality of variable odds accordingly.

33. The method of claim 32, wherein the odds processing step comprises generating the plurality of variable odds by a mathematical trial and error method.

34. The method of claim 28, wherein the odds processing step comprises generating a plurality of odds tables, and a player selects one of the plurality of odds tables to provide the plurality of variable odds.

35. The method of claim 34, wherein one of the plurality of odds tables is a basic odds table which lists the payout odds.

36. The method of claim 28, wherein the odds processing step comprises generating a plurality of sets of variable odds, and a player selecting one of the plurality of sets of variable odds to provide the plurality of variable odds.
